(19) United States
(12) Patent Application Publication
(10) Pub. No.: US 2014/0158083 A1
(43) Pub. Date: Jun. 12, 2014

(54) SPARK IGNITION ENGINE

(71) Applicant: HYUNDAI MOTOR COMPANY, Seoul (KR)

(72) Inventors: Won Jun LEE, Incheon (KR); Soo Hyung WOO, Yongin-si (KR); Jin Kook KONG, Suwon-si, (KR)

(73) Assignee: HYUNDAI MOTOR COMPANY, Seoul (KR)

(21) Appl. No.: 13/889,085

(22) Filed: May 7, 2013

(30) Foreign Application Priority Data
Dec. 7, 2012 (KR) 10-2012-0142055

(51) Int. Cl. F02B 19/06

(52) U.S. Cl. CPC F02B 19/06
USPC 123/275; 123/289

(57) ABSTRACT

A spark ignition engine includes a main combustion chamber configured to suction a mixture through an intake port, a pre-chamber configured to communicate with the main combustion chamber, an auxiliary cylinder configured to communicate with the main combustion chamber via the pre-chamber, an auxiliary intake passage connecting the auxiliary cylinder and the intake port, an auxiliary piston, and a spark plug configured to ignite the mixture in the pre-chamber. The auxiliary piston is configured to slidably reciprocate in the auxiliary cylinder such that the mixture is suctioned from the intake port via the auxiliary intake passage and the mixture is discharged to the main combustion chamber via the pre-chamber.

### CROSS-REFERENCE TO RELATED APPLICATION

This application is based on and claims benefit of priority to Korean Patent Application No. 10-2012-0142055, filed on Dec. 7, 2012 in the Korean Intellectual Property Office, the entire contents of which are hereby incorporated by reference.

### TECHNICAL FIELD

The present inventive concept relates, in general, to a spark ignition engine and, more particularly, to a spark ignition engine that propagates a flame ignited previously to a combustion chamber to burn a mixture.

### BACKGROUND

Internal combustion engines may be classified into spark ignition engines such as gasoline engines that are equipped with a spark plug and promote combustion of a mixture by a separate ignition spark, and compression ignition engines that promote combustion by spontaneous combustion of fuel injected into compressed air in a combustion chamber.

In spark ignition engines, the spark plug is mounted in the combustion chamber and directly provides a spark to the mixture supplied to the combustion chamber to cause ignition. A combustion process takes place such that the ignition occurs at one point in the combustion chamber, and thus a flame front is propagated to the entire combustion chamber. As such, the spark ignition engine has various combustion problems in that a possibility of misfire is relatively high, in that a long flame propagation time is required, and in that a knocking phenomenon is caused by spontaneous combustion of end gas prior to reaching the flame front.

The foregoing is intended merely to aid in the understanding of the background of the present inventive concept, and is not intended to mean that the present inventive concept falls within the purview of the related art that is already known to those skilled in the art.

### DOCUMENTS OF RELATED ART

(Patent Document 1) Korean Unexamined Patent Application Publication No. 10-2010-0036036
(Patent Document 2) U.S. Pat. No. 6,402,057

### SUMMARY

Accordingly, the present inventive concept has been made keeping in mind the above problems occurring in the related art, and the present inventive concept provides a spark ignition engine that allows a mixture suctioned into a combustion chamber to be simultaneously ignited at many points by a plurality of flame nuclei, thereby sharply reducing a possibility of occurrence of misfire and knocking, and promoting more stable combustion.

An aspect of the present inventive concept relates to a spark ignition engine, which includes a main combustion chamber configured to suction a mixture through an intake port, a pre-chamber configured to communicate with the main combustion chamber, an auxiliary cylinder configured to communicate with the main combustion chamber via the pre-chamber, an auxiliary intake passage connecting the auxiliary cylinder and the intake port, an auxiliary piston configured to slidably reciprocate in the auxiliary cylinder such that the mixture is suctioned from the intake port via the auxiliary intake passage and the mixture is discharged to the main combustion chamber via the pre-chamber, and a spark plug configured to ignite the mixture in the pre-chamber.

Another aspect of the present inventive concept encompasses a method of controlling a spark ignition engine. The spark ignition engine includes a main combustion chamber configured to suction a mixture through an intake port, a pre-chamber provided configured to communicate with the main combustion chamber, an auxiliary cylinder configured to communicate with the main combustion chamber via the pre-chamber, an auxiliary intake passage connecting the auxiliary cylinder and the intake port, an auxiliary piston configured to slidably reciprocate in the auxiliary cylinder such that the mixture is suctioned from the intake port via the auxiliary intake passage and the mixture is discharged to the main combustion chamber via the pre-chamber, a spark plug configured to ignite the mixture in the pre-chamber, and at least one injector disposed in the intake port and configured to inject fuel to an upstream side of a portion where the auxiliary intake passage communicates with the intake port. The method includes injecting the fuel from the injector at a point of time when the fuel and air injected by the injector are suctioned to the auxiliary cylinder via the auxiliary intake passage while the auxiliary piston is raised in the auxiliary cylinder. A main piston of the main combustion chamber is lowered so as to perform an intake stroke in which the mixture of fuel and air injected from the injector is suctioned to the main combustion chamber. When the main piston of the main combustion chamber is raised to perform a compression stroke, the auxiliary piston of the auxiliary cylinder is lowered to move the mixture suctioned into the auxiliary cylinder to the pre-chamber. The spark plug is controlled so as to ignite the mixture moved to the pre-chamber. An ignited flame is caused to be formed into a plurality of flame nuclei and to be injected into the mixture compressed in the main combustion chamber.

According to the present inventive concept, the spark ignition engine may allow a mixture suctioned into a combustion chamber to be simultaneously ignited at many points by a plurality of flame nuclei, thereby sharply reducing a possibility of occurrence of misfire and knocking and promoting more stable combustion.

Further, the injector may be installed in the intake port. Thereby, the spark ignition engine may be configured in a simple structure at an inexpensive cost compared to a direct injection engine in which an injector is installed in a combustion chamber. Further, the spark ignition engine may be improved in durability and operational stability of related components such as an auxiliary cylinder and an auxiliary piston.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 shows a configuration of a spark ignition engine according to an embodiment of the present inventive concept.

FIG. 2 shows an example of a method of controlling a spark ignition engine according to an embodiment of the present inventive concept.

### DETAILED DESCRIPTION

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

Hereinafter, a spark ignition engine according to an embodiment of the present inventive concept will be described in detail with reference to the accompanying drawings.

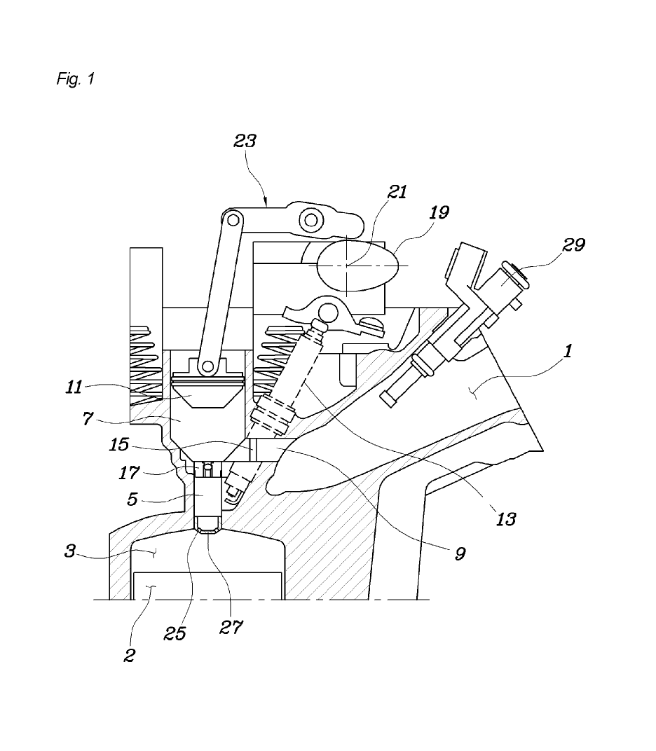

Referring to FIG. 1, a spark ignition engine according to an embodiment of the present inventive concept may include a main combustion chamber 3 formed so as to suction a mixture through an intake port 1, a pre-chamber 5 provided so as to communicate with the main combustion chamber 3, an auxiliary cylinder 7 provided so as to communicate with the main combustion chamber 3 via the pre-chamber 5, an auxiliary intake passage 9 connecting the auxiliary cylinder 7 and the intake port 1, an auxiliary piston 11 provided to slidably reciprocate in the auxiliary cylinder 7 so as to be able to suction the mixture from the intake port 1 via the auxiliary intake passage 9 and to discharge the mixture to the main combustion chamber 3 via the pre-chamber 5, and an spark plug 13 installed to ignite the mixture in the pre-chamber 5.

To cause combustion in the main combustion chamber 3 that substantially generates power, the mixture suctioned into the auxiliary cylinder 7 may be ignited in the pre-chamber 5. Flame nuclei ignited in the pre-chamber 5 may be injected into the mixture compressed in the main combustion chamber 3. Thereby, an ignition process may be caused to simultaneously take place at many points in the main combustion chamber 3, thereby improving the stability of mixture ignition so as to be able to sharply reduce a possibility of occurrence of misfire and knocking and to promote more stable combustion.

A first check valve 15 may be installed in the auxiliary intake passage 9 so as to allow the mixture to only flow from the intake port 1 toward the auxiliary cylinder 7. A second check valve 17 may be installed between the auxiliary cylinder 7 and the pre-chamber 5 so as to allow the mixture to only flow from the auxiliary cylinder 7 toward the pre-chamber 5.

Thus, when the auxiliary piston 11 is raised in the auxiliary cylinder 7, the mixture may be allowed to be suctioned from the intake port 1, past the auxiliary intake passage 9 and the first check valve 15, into the auxiliary cylinder 7. Here, the main combustion chamber 3 and the pre-chamber 5 may be kept closed off from the auxiliary cylinder 7 by the second check valve 17. When the auxiliary piston 11 is lowered, the first check valve 15 may be kept closed, and the second check valve 17 may be opened. Thus, the mixture in the auxiliary cylinder 7 may be directed toward the main combustion chamber 3 via the pre-chamber 5.

The auxiliary piston 11 may be connected with a link driving mechanism 23 that is configured to reciprocate the auxiliary piston 11 using mechanical displacement formed by a driving cam 19 installed on a camshaft 21 provided so as to open/close a valve of the main combustion chamber 3. Although a detailed structure of, for instance, a return spring is omitted, the link driving mechanism 23 may be realized in various methods using a link structure capable of promoting upward/downward movement of the auxiliary piston 11 by displacement generated according to a cam profile of the camshaft 21.

Further, to drive the auxiliary piston 11 independent of driving of the camshaft 21, a mechanism may be configured to cause the auxiliary piston 11 to be raised/lowered using a separate actuator (not separately shown).

A nozzle cap 27 having a plurality of injection holes 25 may be installed on a boundary between the pre-chamber 5 and the main combustion chamber 3 so as to be able to inject a flame from the pre-chamber 5 into the main combustion chamber 3 via the plurality of injection holes 25.

Thus, the mixture in the auxiliary cylinder 7 may be ignited by the spark plug 13 while passing through the pre-chamber 5 due to the downward movement of the auxiliary piston 11. When passing through the nozzle cap 27, the mixture may be dispersed into a plurality of flame nuclei in the main combustion chamber 3.

At least one injector 29 may be installed in the intake port 1 so as to be able to inject fuel to an upstream side of a portion where the auxiliary intake passage 9 communicates with the intake port 1.

For example, when only one injector 29 is installed in the intake port 1, the fuel-air ratio of the mixture suctioned into the auxiliary cylinder 7 may be configured to be different from the one of the mixture suctioned into the main combustion chamber 3 in a method such as multistage injection by distinguishing when the mixture is suctioned into the auxiliary cylinder 7 and when the mixture is mainly suctioned into the main combustion chamber 3 via an intake valve of the intake port 1 from each other. Also the fuel-air ratios of the mixtures of both the auxiliary cylinder 7 and the main combustion chamber 3 are equal to each other, when the injection is performed with a method such as single stage injection.

Further, when two injectors 29 are installed in the intake port 1, one of the two injectors 29 is designed to inject the fuel so as to form the mixture supplied to the auxiliary cylinder 7 via the auxiliary intake passage 9, and the other of the two injectors 29 is designed to inject the fuel so as to form the mixture supplied to the main combustion chamber 3 via the intake port 1. Thereby, the fuel-air ratios of the auxiliary cylinder 7 and the main combustion chamber 3 are formed in completely independent ways, so that a wider range of combustion control of the engine can be secured.

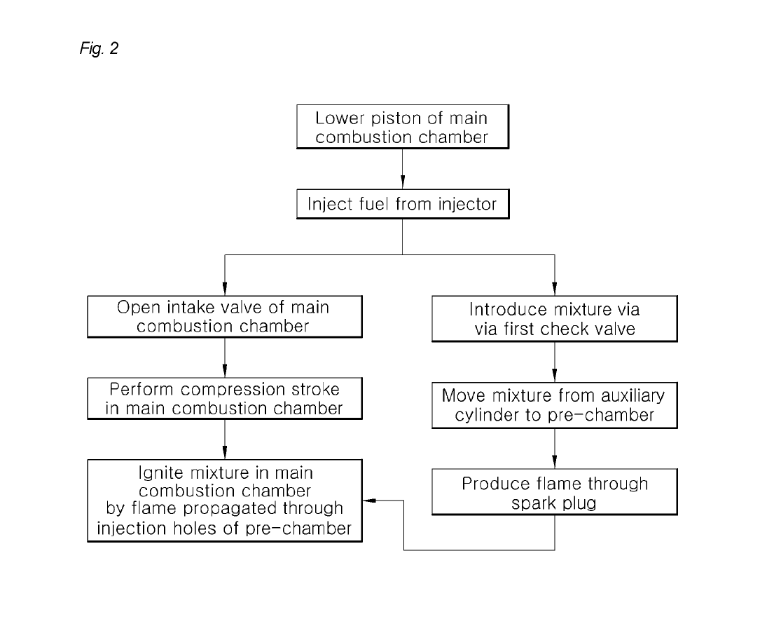

As shown in FIG. 2, an example of a method of controlling a spark ignition engine is described. The spark ignition engine may be configured as described above and illustrated in FIG. 1. The injector 29 may inject the fuel at a point of time when the fuel and air injected by the injector 29 can be suctioned to the auxiliary cylinder 7 via the auxiliary intake passage 9 while the auxiliary piston 11 is raised in the auxiliary cylinder 7.

In detail, in FIG. 2, when a main piston 2 (not separately shown in FIG. 1) of the main combustion chamber 3 begins to be lowered, the injector 29 may be designed to inject the fuel. Thereby, the mixture can flow into the auxiliary cylinder 7 via the auxiliary intake passage 9, and simultaneously can be supplied to the main combustion chamber 3. Thus, the main piston may be lowered, and simultaneously the auxiliary piston 11 may be raised.

When the main piston of the main combustion chamber 3 is raised to perform a compression stroke, the spark plug 13 may be controlled, and the auxiliary piston 11 of the auxiliary cylinder 7 is lowered so as to move the mixture suctioned into the auxiliary cylinder 7 to the pre-chamber 5 and ignite the mixture moved to the pre-chamber 5 at nearly the same time. Ultimately, an ignited flame may be formed into a plurality of flame nuclei, and may be injected into the mixture compressed in the main combustion chamber 3.

Here, as described above, when only one injector 29 is installed in the intake port 1, the multistage injection may be allowed to be performed so that the fuel-air ratio of the mixture flowing into the auxiliary cylinder 7 via the auxiliary intake passage 9 can be adjusted. When two injectors are installed in the intake port, the injection can be controlled so as to independently determine amounts of fuel and air in the auxiliary cylinder 7 and the main combustion chamber 3, thereby determining a wide range of the fuel-air ratios.

Although specific embodiments of the present inventive concept have been described for illustrative purposes, those skilled in the art will appreciate that various modifications, additions and substitutions are possible, without departing from the scope and spirit of the inventive concept as defined in the appended claims and their equivalents.

What is claimed is:

1. A spark ignition engine, comprising:
a main combustion chamber configured to suction a mixture through an intake port;
a pre-chamber configured to communicate with the main combustion chamber;
an auxiliary cylinder configured to communicate with the main combustion chamber via the pre-chamber;
an auxiliary intake passage connecting the auxiliary cylinder and the intake port;
an auxiliary piston configured to slidably reciprocate in the auxiliary cylinder such that the mixture is suctioned from the intake port via the auxiliary intake passage and the mixture is discharged to the main combustion chamber via the pre-chamber; and
a spark plug configured to ignite the mixture in the pre-chamber.

2. The spark ignition engine according to claim 1, further comprising:
a first check valve disposed in the auxiliary intake passage and configured to allow the mixture to only flow from the intake port toward the auxiliary cylinder; and
a second check valve disposed between the auxiliary cylinder and the pre-chamber and configured to allow the mixture to only flow from the auxiliary cylinder toward the pre-chamber.

3. The spark ignition engine according to claim 2, wherein:
the auxiliary piston is connected with a link driving mechanism,
the link driving mechanism is configured to reciprocate the auxiliary piston using mechanical displacement formed by a driving cam disposed on a camshaft such that a valve of the main combustion chamber is opened/closed.

4. The spark ignition engine according to claim 2, further comprising a nozzle cap having a plurality of injection holes and disposed on a boundary between the pre-chamber and the main combustion chamber, the nozzle cap being configured to inject a flame from the pre-chamber into the main combustion chamber via the plurality of injection holes.

5. The spark ignition engine according to claim 2, further comprising at least one injector disposed in the intake port and configured to inject fuel to an upstream side of a portion where the auxiliary intake passage communicates with the intake port.

6. The spark ignition engine according to claim 5, wherein:
the two injectors are disposed in the intake port, and
one of the two injectors is configured to inject the fuel to form the mixture supplied to the auxiliary cylinder via the auxiliary intake passage, whereas the other of the two injectors is configured to inject the fuel to form the mixture supplied to the main combustion chamber via the intake port.

7. A method of controlling a spark ignition engine, the spark ignition engine comprising:
a main combustion chamber configured to suction a mixture through an intake port;
a pre-chamber configured to communicate with the main combustion chamber;
an auxiliary cylinder configured to communicate with the main combustion chamber via the pre-chamber;
an auxiliary intake passage connecting the auxiliary cylinder and the intake port;
an auxiliary piston configured to slidably reciprocate in the auxiliary cylinder such that the mixture is suctioned from the intake port via the auxiliary intake passage and the mixture is discharged to the main combustion chamber via the pre-chamber;
a spark plug configured to ignite the mixture in the pre-chamber; and
at least one injector disposed in the intake port and configured to inject fuel to an upstream side of a portion where the auxiliary intake passage communicates with the intake port,
the method comprising:
injecting the fuel from the injector at a point of time when the fuel and air injected by the injector are suctioned to the auxiliary cylinder via the auxiliary intake passage while the auxiliary piston is raised in the auxiliary cylinder;
lowering a main piston of the main combustion chamber so as to perform an intake stroke in which the mixture of fuel and air injected from the injector is suctioned to the main combustion chamber;
when the main piston of the main combustion chamber is raised to perform a compression stroke, lowering the auxiliary piston of the auxiliary cylinder to move the mixture suctioned into the auxiliary cylinder to the pre-chamber; and
controlling the spark plug so as to ignite the mixture moved to the pre-chamber, and causing an ignited flame to be formed into a plurality of flame nuclei and to be injected into the mixture compressed in the main combustion chamber.

8. The method according to claim 7, wherein the injector performs multistage injection so as to be able to adjust a fuel-air ratio of the mixture flowing into the auxiliary cylinder via the auxiliary intake passage and to adjust a fuel-air ratio of the mixture flowing into the main combustion chamber via the intake port.
